(19) United States
(12) Patent Application Publication
(10) Pub. No.: US 2006/0198547 A1
(43) Pub. Date: Sep. 7, 2006

(54) Apparatus for separating particulates from a speaker system

(75) Inventors: Patrick A. Hampton, Deerfield Beach, FL (US); Anabel M. Nogueiras, Miramar, FL (US); Julio C. Castaneda, Coral Springs, FL (US); Matthew R. Michieli, Gilbert, AZ (US)

Correspondence Address: AKERMAN SENTERFITT, P.O. BOX 3188, WEST PALM BEACH, FL, 33402-3188, US

(73) Assignee: Motorola, Inc., Schaumburg, IL (US)

(21) Appl. No.: 11/074,097

(22) Filed: Mar. 7, 2005

(51) Int. Cl. H04R 1/02

(52) U.S. Cl. 381/395; 381/391

(57) ABSTRACT

An audio device (200, 220, 230) includes an enclosure (202) having one or more openings (206A-B), one or more speaker systems (214) carried in the enclosure for receiving signals from a corresponding audio source (308), and one or more magnetic elements (216, 222, 232) coupled to the enclosure. The magnetic elements attract particulates (204, 212) entering one or more openings and separate said particulates from one or more speaker systems.

### FIELD OF THE INVENTION

This invention relates generally to speaker systems, and more particularly to an apparatus for separating particulates from a speaker system.

### BACKGROUND OF THE INVENTION

In speaker systems a magnet is used in conjunction with a voice coil coupled to a diaphragm to produce airwaves corresponding to electrical signals supplied to the voice coil. Most speaker systems use enclosures with ports for conducting airwaves produced by the diaphragm. These ports are sometimes open to the air, or covered by a conventional mesh to limit entry of particulates in the speaker enclosure (see FIGS. 1-2, respectively).

As the density of the mesh increases, however, acoustic resistance increases as well which impacts the quality of the sound produced by a speaker system. Accordingly, meshes are generally chosen with a density that keeps large particulates out of the enclosure of a speaker system while minimizing impact to acoustic quality. Lower density meshes, however, allow small particulates to enter the speaker enclosure (see FIG. 2).

Over the course of time, the magnet of the speaker attracts the small particulates entering the port, thereby accumulating on the diaphragm (see FIGS. 1-2). As particulates collect on the diaphragm acoustic performance of the speaker system degrades. Distortions such as buzz, or in extreme cases, muffled sound can result from these contaminants.

### SUMMARY OF THE INVENTION

Embodiments in accordance with the invention provide an apparatus for separating particulates from a speaker system.

In a first embodiment of the present invention, an audio device includes an enclosure having one or more openings, one or more speaker systems carried in the enclosure for receiving signals from a corresponding audio source, and one or more magnetic elements coupled to the enclosure for attracting particulates entering the one or more openings and for separating said particulates from one or more speaker systems.

In a second embodiment of the present invention, a device includes one or more speaker systems, a processor coupled to the speaker systems and for controlling operations thereof, one or more magnetic elements, and an enclosure having one or more openings for carrying the aforementioned components of the device. The magnetic elements are coupled to the enclosure for attracting particulates entering the one or more openings and for separating said particulates from the one or more speaker systems. The device can optionally also include a power supply, an audio system, and a memory coupled to the processor.

In a third embodiment of the present invention, a selective call device (SCD) includes a transceiver for exchanging information with a communication system, an audio system, one or more speaker systems for receiving audio signals from the audio system, a memory, a processor coupled to the transceiver, the audio system, the speaker systems, and the memory for controlling operations thereof, one or more magnetic elements, and an enclosure having one or more openings for carrying the aforementioned components of the device. The magnetic elements are coupled to the enclosure for attracting particulates entering the one or more openings and for separating said particulates from the one or more speaker systems.

### BRIEF DESCRIPTION OF THE DRAWINGS

FIGS. 1-2 depict prior art embodiments of audio devices;

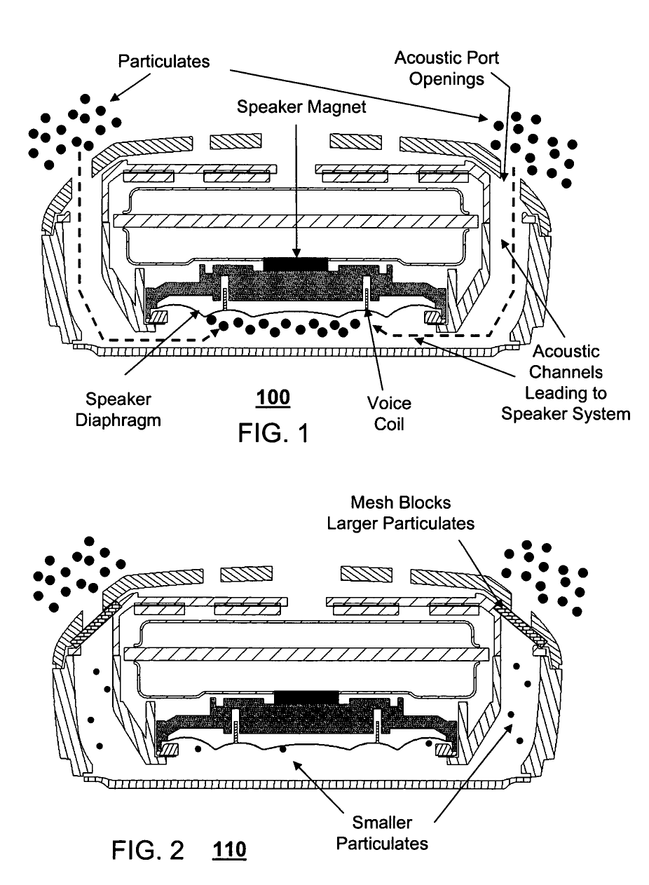

FIGS. 3-5 depict alternate embodiments of audio devices according to the present invention; and

FIG. 6 illustrates a block diagram of alternate embodiments of a device according to the present invention.

### DETAILED DESCRIPTION OF THE DRAWINGS

While the specification concludes with claims defining the features of embodiments of the invention that are regarded as novel, it is believed that the embodiments of the invention will be better understood from a consideration of the following description in conjunction with the figures, in which like reference numerals are carried forward.

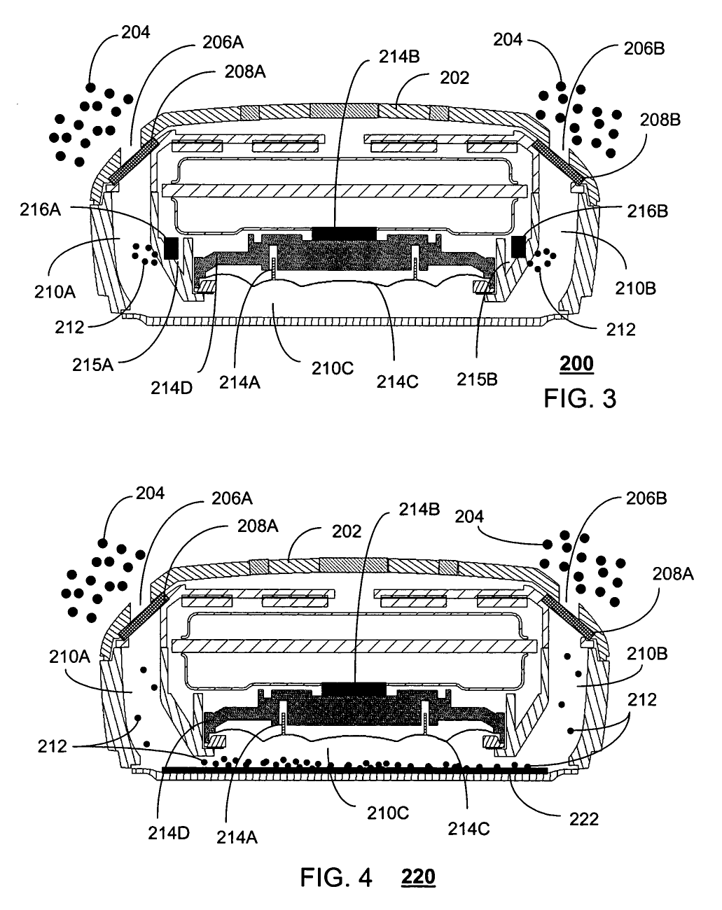

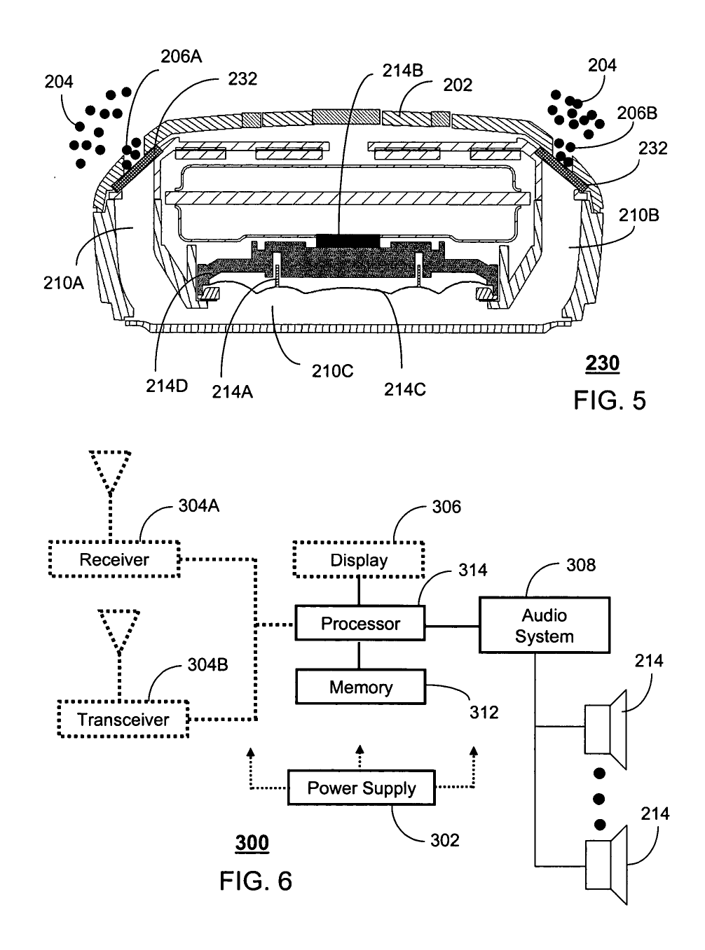

FIGS. 3-5 depict alternate embodiments of speaker systems 200, 220, 230 according to the present invention. FIG. 3 shows a cross-section of a first embodiment of an audio device 200 having an enclosure 202 with two openings 206A-B. The enclosure 202 has a speaker system 214 with conventional components including a voice coil 214A, a magnet 214B, a diaphragm 214C, and a frame 214D. The voice coil 214A receives audio signals from a source such as the audio system 308 of FIG. 6. In conjunction with the magnet 214B, the voice coil 214A causes the diaphragm 214C to vibrate, which in turn produces airwaves corresponding to the signals received by the voice coil 214A. The frame 214D is coupled to the foregoing components 214A-C and the enclosure 202 for support thereof. Although only one speaker system 214 is shown in FIGS. 3-5, it will be appreciated that additional speaker systems 214 can be used with the present invention.

In this embodiment, the audio device 200 further includes conventional meshes (or felts) 208A-B for preventing large particulates 204 from entering the openings 206A-B. Smaller particulates 212, however, can still enter acoustic channels 210A-B of the enclosure 202. To inhibit the particulates 212 from reaching the diaphragm 214C by way of the attraction force produced by the magnet 214B, magnetic elements 216A-B are placed in compartments 215A-B of the enclosure 202. The magnetic elements 216A-B attract the smaller particulates 212 entering channels 210A-B, thereby preventing entry to a channel 210C of the speaker system 214. Consequently, there is no opportunity for magnet 214B to attract particulates 212 to diaphragm 214C. The magnetic elements 216A-B can be of any form factor (e.g., a slug) suitable for the compartments 215A-B. The compartments 215A-B can be near the openings 206A-B or any other position that attracts the particulates 212 before reaching channel 210C. “Near” in this regard, can mean proximate to or relatively close to the opening such that the function of attracting particulates 212 is substantially achieved while avoiding particulates falling within the channel 210C.

It will be appreciated by an artisan with skill in the art that the foregoing embodiment can be modified to operate without the conventional meshes 208A-B while preserving the function to prevent the large and small particulates 204, 212 from reaching the diaphragm 214C. Instead of using compartments 215A-B of the enclosure 202, the magnetic elements 216A-B can in the alternative be an integral part of an assembly of the speaker system 214. That is, the magnetic elements 216A-B can be coupled to, for example, a modified frame 214D that can carry said elements in a position (e.g., similar to that shown in FIG. 3), which prevents particulates 212 from reaching the diaphragm 214C.

FIG. 4 shows an alternate embodiment of an audio device 220 according to the present invention. The audio device 220 includes a conventional magnetic strip 222 coupled to the enclosure 202 in an area of the acoustic channel 210C. A double-sided conventional adhesive, or other conventional means for adhesion, can be used to couple the magnetic strip 222 to the enclosure 202. In this embodiment, the smaller particulates 212 enter acoustic channels 210A-B and are trapped by the magnetic strip 222 from making contact with the diaphragm 214C. To attract the particulates 212 to the magnetic strip 222, said strip 222 is designed with a stronger magnetic force than the magnet 214B. As in the embodiment of FIG. 3, the present embodiment can be modified by removing the meshes 208A-B, while maintaining the entrapment properties of the magnetic strip 222. Moreover, the embodiments of FIGS. 3 and 4 can be combined in whole or in part to further protect diaphragm 214C from contaminants that can impact acoustic performance.

FIG. 5 shows yet another embodiment of an audio device 230 according to the present invention. In this embodiment, the audio device 230 includes meshes 232 integrating therein magnetic elements for attracting particulates 204 of all sizes. These particulates 204 accumulate in the openings 206A-B, which can be easily removed by a cloth or other suitable material when too many particulates accumulate thereby affecting the acoustic quality of the audio device 230. Modifications can be made to this embodiment without departing from the scope and spirit of the claims described below. For example, this embodiment can be combined in whole or in part with any of the foregoing embodiments of FIGS. 3-4 to further enhance protection of said speaker system 214.

FIG. 6 illustrates a block diagram of alternate embodiments of a device 300 according to the present invention. In a first embodiment, the device 300 includes a power supply 302, an audio system 308, one or more speaker systems 214, a memory 312, and a processor 314. The power supply 302 utilizes conventional technology for supplying power to the components 302-314 of the device 300. The audio system 308 includes conventional technology for supplying audio signals to the voice coils 214A of the one or more speaker systems 214. The processor 314 includes conventional computing components such as one or more microprocessors and/or DSPs (Digital Signal Processors) coupled to the memory 312 for software operations and data manipulations. The memory 312 utilizes conventional storage technology such as Flash memory, RAM (Random Access Memory), DVD or CD-ROM media device, or like storage media. Portions of the memory 312 can be removable from the device 300, while other portions can be fixed therein. The processor 314 controls operations of the device 300 according to conventional software of applicable use to the present invention.

The foregoing components 302-314 can be carried by an enclosure 202 (like the cross-section of FIGS. 3-5) having one or more openings 206A-B for conducting audible signals from the speaker system 214. One or more magnetic elements can be coupled to the enclosure 202 according to any of the embodiments of FIGS. 3-5 singly or in combination for separating particulates 204, 212 from the diaphragm 214C of each speaker system 214. The aforementioned device 300 can be used for many applications. For example, the device 300 can be used for audio entertainment. A portion of the memory 312 (e.g., a CD ROM) can supply pre-recorded music to the processor 312 for processing with conventional multimedia software. The processed data can then be supplied to the audio system 308 for conveying audio signals to the speaker system 214.

In a supplemental embodiment, device 300 further includes a conventional receiver 304A, which can receive over-the-air (by way of the antenna shown in FIG. 6) signals from a communication system, or by conventional wired means over, for example, the Internet. The signals received can include musical data, which the processor 314 can process with conventional software and convey audio signals from the audio system 308 to the speaker system 214.

In yet another supplemental embodiment, the device 300 can be embodied in a selective call device (SCD) such as, for example, a cell phone or laptop computer which includes a conventional wireless or wired transceiver 304B (in place of the aforementioned receiver 304A) and a conventional display 306 for exchanging messages with a communications system, and for conveying images to a user of the SCD, respectively. In this embodiment, the device 300 can receive multimedia data (e.g., streaming audio and/or video, multimedia files, etc.) which the processor 314 can process and convey therefrom audio signals to the speaker systems 214 by way of the audio system 308, and/or images to the display 306.

It should be evident that the present invention may be used for many applications. Thus, although the description is made for particular arrangements, the intent and concept of the invention is suitable and applicable to other arrangements and applications not described herein. For example, the multiple embodiments of the audio devices 200, 220 and 230 of FIGS. 3-5 can represent standalone audio systems used by a stereo tuner and/or amplifier (not shown). Alternatively, the audio devices 200, 220 and 230 can be an integral part of the embodiments of device 300 as described above. In this regard, integral can mean integrated or included with the speaker system. It would be clear therefore to those skilled in the art that modifications to the disclosed embodiments described herein can be effected without departing from the spirit and scope of the invention.

Accordingly, the described embodiments ought to be construed to be merely illustrative of some of the more prominent features and applications of the invention. It should also be understood that the claims are intended to cover the structures described herein as performing the recited function and not only structural equivalents. Therefore, equivalent structures that read on the description are to be construed to be inclusive of the scope of the invention as defined in the following claims. Thus, reference should be made to the following claims, rather than to the foregoing specification, as indicating the scope of the invention.

What is claimed is:

1. A audio device, comprising:
an enclosure having one or more openings;
one or more speaker systems carried in the enclosure for receiving signals from a corresponding audio source; and
one or more magnetic elements coupled to the enclosure for attracting particulates entering the one or more openings and for separating said particulates from one or more speaker systems.

2. The audio device of claim 1, wherein said enclosure further comprises one or more compartments, wherein said one or more magnetic elements have a form-factor fitted to said compartments, and wherein said magnetic elements are positioned in said compartments.

3. The audio device of claim 2, wherein said compartments are positioned near the one or more openings of the enclosure.

4. The audio device of claim 1, wherein one or more of the magnetic elements is a corresponding one or more magnetic strips coupled to the enclosure.

5. The audio device of claim 4, wherein the magnetic strips are positioned below a diaphragm of each speaker system.

6. The audio device of claim 1, wherein the one or more magnetic elements are an integral part of each speaker system, and wherein each speaker system has corresponding one or more magnetic elements positioned to separate the particulates attracted thereto from a diaphragm of said speaker system.

7. The audio device of claim 1, wherein the one or more magnetic elements are an integral part of a corresponding one or more meshes, and wherein each mesh is coupled to the one or more openings of the enclosure for collecting particulates thereon.

8. A device, comprising:
one or more speaker systems for receiving audio signals;
a processor coupled to the speaker systems for controlling operations thereof;
one or more magnetic elements; and
an enclosure having one or more openings for carrying the speaker systems, the processor, and the magnetic elements, wherein said magnetic elements are coupled to the enclosure for attracting particulates entering the one or more openings and for separating said particulates from the one or more speaker systems.

9. The device of claim 8, wherein said enclosure further comprises one or more compartments, wherein said one or more magnetic elements have a form-factor fitted to said compartments, and wherein said magnetic elements are positioned in said compartments.

10. The device of claim 9, wherein said compartments are positioned near the one or more openings of the enclosure.

11. The device of claim 8, wherein one or more of the magnetic elements is a corresponding one or more magnetic strips coupled to the enclosure.

12. The device of claim 11, wherein the magnetic strips are positioned below a diaphragm of each speaker system.

13. The device of claim 8, wherein the one or more magnetic elements are an integral part of each speaker system, and wherein each speaker system has corresponding one or more magnetic elements positioned to separate the particulates attracted thereto from a diaphragm of said speaker system.

14. The device of claim 8, wherein the one or more magnetic elements are an integral part of a corresponding one or more meshes, and wherein each mesh is coupled to the one or more openings of the enclosure for collecting particulates thereon.

15. The device of claim 8, further comprising a receiver coupled to the processor, wherein said processor is programmed to:
receive from the receiver data coupled to a source of said data;
process said data; and
convey audio signals from an audio system to the one or more speaker systems.

16. A selective call device (SCD), comprising:
a transceiver for exchanging information with a communication system;
an audio system;
one or more speaker systems for receiving audio signals from the audio system;
a memory;
a processor coupled to the transceiver, the audio system, the speaker systems, and the memory for controlling operations thereof;
one or more magnetic elements; and
an enclosure having one or more openings for carrying the transceiver, the audio system, the speaker systems, the memory, the processor, and the magnetic elements, wherein said magnetic elements are coupled to the enclosure for attracting particulates entering the one or more openings and for separating said particulates from the one or more speaker systems.

17. The SCD of claim 16, wherein said enclosure further comprises one or more compartments, wherein said one or more magnetic elements have a form-factor fitted to said compartments, wherein said magnetic elements are positioned in said compartments, and wherein said compartments are positioned near the one or more openings of the enclosure.

18. The SCD of claim 16, wherein one or more of the magnetic elements is a corresponding one or more magnetic strips coupled to the enclosure, and wherein the magnetic strips are positioned below a diaphragm of each speaker system.

19. The SCD of claim 16, wherein the one or more magnetic elements are an integral part of a corresponding one or more meshes, and wherein each mesh is coupled to the one or more openings of the enclosure for collecting particulates thereon.
